(19) United States
(12) Patent Application Publication
(10) Pub. No.: US 2025/0030294 A1
(43) Pub. Date: Jan. 23, 2025

(54) ROTATING ELECTRICAL MACHINE WIRING COMPONENT, ROTATING ELECTRICAL MACHINE WIRING COMPONENT-CONNECTION STRUCTURE, AND ROTATING ELECTRICAL MACHINE ASSEMBLY MANUFACTURING METHOD

(71) Applicant: Proterial, Ltd., Tokyo (JP)

(72) Inventor: Kenichi EGAMI, Tokyo (JP)

(73) Assignee: Proterial, Ltd., Tokyo (JP)

(21) Appl. No.: 18/766,329

(22) Filed: Jul. 8, 2024

(30) Foreign Application Priority Data
Jul. 21, 2023 (JP) 2023-119379

(51) Int. Cl. H02K 3/28; H02K 15/00

(52) U.S. Cl. CPC H02K 3/28; H02K 15/0068; H02K 2215/00

(57) ABSTRACT

A rotating electrical machine wiring component has a wire shape and is configured to be connected to a plurality of ends of an armature winding aligned in parallel in a predetermined alignment direction. The rotating electrical machine wiring component includes a weld portion that is provided at one longitudinal end and is connected to the plurality of ends of the armature winding by welding, wherein the weld portion extends in an extending direction along the alignment direction, and wherein the weld portion comprises protrusions that protrude respectively along the plurality of ends of the armature winding.

### CROSS-REFERENCE TO RELATED APPLICATIONS

The present application is based on Japanese patent application No. 2023-119379 filed on Jul. 21, 2023, the entire contents of which are incorporated herein by reference.

### TECHNICAL FIELD

This disclosure relates to a rotating electrical machine wiring component, a rotating electrical machine wiring component-connection structure, and a rotating electrical machine assembly manufacturing method.

### BACKGROUND OF THE INVENTION

In Patent Literature 1, the present applicant proposed a conventional motor connecting member that connects a motor winding and a terminal block. The motor connecting member described in Patent Literature 1 is formed by plastically deforming a solid wire having a circular cross-section and includes a terminal portion to be connected to the terminal block, a winding connecting portion to be connected to an end of the motor winding, and an extended portion extending between the terminal portion and the winding connecting portion. The winding connecting portion is formed in a rectangular plate shape, and both longitudinal ends thereof are respectively connected to the ends of the motor winding by welding.
Citation List Patent Literature 1: JP2014-207827A

### SUMMARY OF THE INVENTION

In recent years, rotating electrical machines have come to be widely used as drive sources for automobiles. In such rotating electrical machines, thicker armature windings tend to be used as the output power increases. When welding thick armature windings, the welding process may take a long time since heat is likely to diffuse. The longer welding process causes an increase in manufacturing costs.

Therefore, it is an object of the invention to provide a rotating electrical machine wiring component that can be quickly welded to an armature winding of a rotating electrical machine, a rotating electrical machine wiring component-connection structure, and a method for manufacturing a rotating electrical machine assembly.

To solve the problem described above, one aspect of the invention provides a rotating electrical machine wiring component having a wire shape and configured to be connected to a plurality of ends of an armature winding aligned in parallel in a predetermined alignment direction, the rotating electrical machine wiring component comprising:
a weld portion that is provided at one longitudinal end and is connected to the plurality of ends of the armature winding by welding,
wherein the weld portion extends in an extending direction along the alignment direction, and
wherein the weld portion comprises protrusions that protrude respectively along the plurality of ends of the armature winding.

To solve the problem described above, another aspect of the invention provides a rotating electrical machine wiring component-connection structure configured to connect a plurality of ends of an armature winding aligned in parallel in a predetermined alignment direction to a rotating electrical machine wiring component having a wire shape, the rotating electrical machine wiring component-connection structure comprising:
a weld portion that is provided at one longitudinal end of the rotating electrical machine wiring component and is connected to the plurality of ends of the armature winding by welding,
wherein the weld portion extends in an extending direction along the alignment direction, wherein the weld portion comprises protrusions that protrude respectively along the plurality of ends of the armature winding, and
wherein the protrusions are melted and fused respectively with the plurality of ends of the armature winding.

To solve the problem described above, a still another aspect of the invention provides a method for manufacturing a rotating electrical machine assembly that comprises a rotating electrical machine, in which a plurality of ends of an armature winding led out of an armature core are aligned in parallel to each other in a predetermined alignment direction, and a rotating electrical machine wiring component having a wire shape and connected to the plurality of ends of the armature winding, the method comprising:
forming, at one end in a longitudinal direction of the rotating electrical machine wiring component, a weld portion that comprises protrusions protruding respectively along the plurality of ends of the armature winding;
arranging the weld portion of the rotating electrical machine wiring component so as to face the plurality of ends of the armature winding; and
welding the weld portion to the plurality of ends of the armature winding by melting the protrusions together with the plurality of ends of the armature winding.

### Advantageous Effects of the Invention

According to a rotating electrical machine wiring component, a rotating electrical machine wiring component-connection structure, and a rotating electrical machine assembly manufacturing method of the invention, it is possible to quickly weld an armature winding of a rotating electrical machine to a rotating electrical machine wiring component.

### BRIEF DESCRIPTION OF DRAWINGS

FIG. 1 is a perspective view showing a rotating electrical machine assembly in an embodiment.

FIG. 2A is a perspective view showing a portion of the rotating electrical machine assembly before a welding step is performed.

FIG. 2B is a perspective view showing the portion of the rotating electrical machine assembly after the welding step is performed.

FIG. 3 is a configuration diagram illustrating the rotating electrical machine assembly and a terminal block as viewed from a side.

FIG. 4 is a circuit diagram illustrating an example of an electric circuit configuration formed by armature windings in a rotating electrical machine.

FIG. 5 is a perspective view showing one longitudinal end of a first busbar, and one and other ends of a U-phase armature winding.

FIG. 6A is a plan view showing a weld portion of the first busbar.

FIG. 6B is an explanatory diagram illustrating the ends of the U-phase armature winding superimposed on the weld portion of the first busbar.

FIG. 7A is a perspective view showing a wire-shaped material used to form the first busbar.

FIG. 7B is a perspective view showing the wire-shaped material when one end in a longitudinal direction is crushed into a flat plate portion that is rectangular in the longitudinal direction.

FIGS. 8A and 8B are explanatory diagrams illustrating a process of forming protrusions on the flat plate portion.

### DETAILED DESCRIPTION OF THE INVENTION

### Embodiment

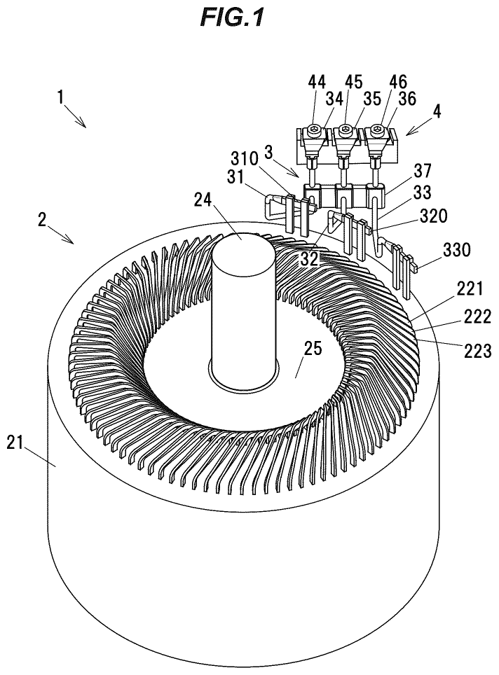

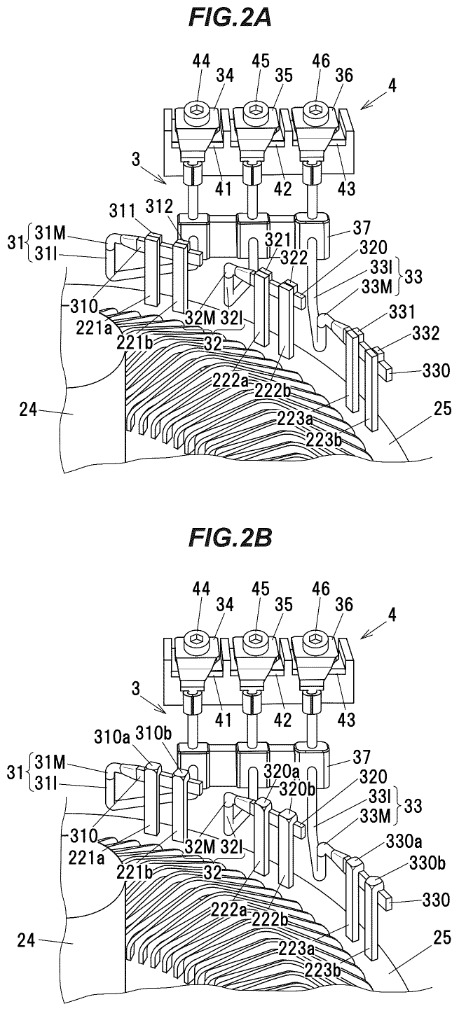

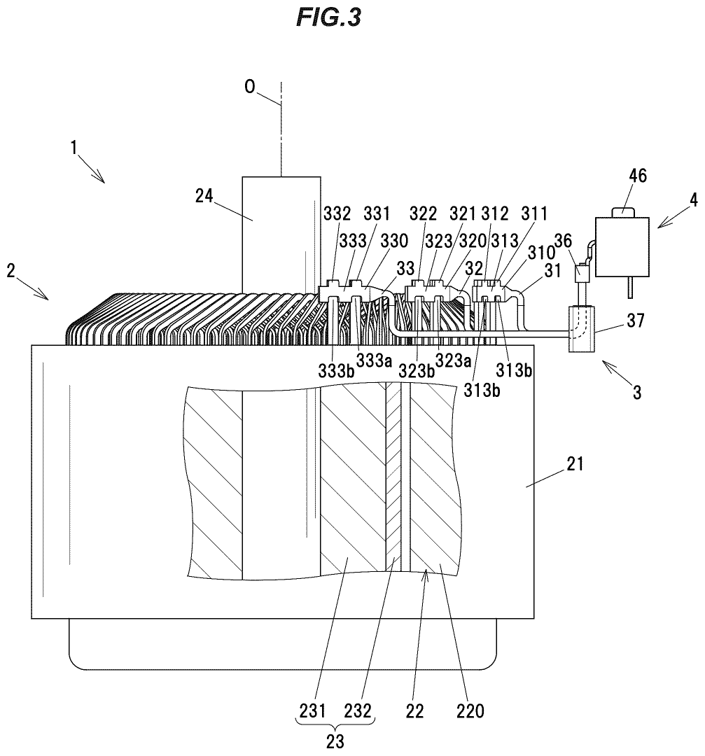

FIG. 1 is a perspective view showing a rotating electrical machine assembly 1 in an embodiment together with a terminal block 4. FIG. 2A is a perspective view showing a portion of the rotating electrical machine assembly 1 before a welding step is performed. FIG. 2B is a perspective view showing the portion of the rotating electrical machine assembly 1 after the welding step is performed. FIG. 3 is a configuration diagram illustrating the rotating electrical machine assembly 1 and the terminal block 4 as viewed from a side. The rotating electrical machine assembly 1 has a rotating electrical machine 2 and a busbar unit 3. In FIG. 3, the rotating electrical machine 2 is partially broken away to illustrate its internal structure.

The rotating electrical machine 2 is mounted on a vehicle as a drive source for travel and also as a generator for generating electricity during regenerative braking and is connected to an inverter (not shown) through the busbar unit 3 and the terminal block 4. The rotating electrical machine 2 is a three-phase motor and its armature windings 221 to 223 (described later) are electrically connected to first to third washers 41 to 43 of the terminal block 4 by the busbar unit 3.

The rotating electrical machine 2 has a case 21 having a bottomed cylindrical shape, an armature 22 which is a stator fixed on the inner side of the case 21, a rotor 23 arranged on the inner side of the armature 22, a shaft 24 that passes through the center of the rotor 23 and is supported so as to be able to rotate integrally with the rotor 23, and a disk-shaped lid member 25 made of a molding resin and covering an opening of the case 21.

In the armature 22, the U-, V- and W-phase armature windings 221 to 223 are wound on an armature core 220 that is an annular iron core surrounding the rotor 23. In more particular, one of the U-, V- and W-phase windings 221 to 223 is wound around each of plural teeth provided on the armature core 220. The armature core 220 is made of a magnetic material such as steel. The armature windings 221 to 223 are rectangular insulated wires having a rectangular cross-section. The armature windings 221 to 223 are molded in the lid member 25 so as to be partially exposed from the lid member 25 to the outside of the case 21.

The rotor 23 has a cylindrical rotor core 231 having a through-hole for insertion of the shaft 24, and plural magnets 232 arranged on the outer peripheral portion of the rotor core 231. The magnets 232 have magnetic poles provided in such a manner that S-poles and N-poles are located alternately along a circumferential direction of the rotor core 231. The shaft 24 is rotatably supported on the case 21 by a bearing (not shown) and rotates about a rotation axis O.

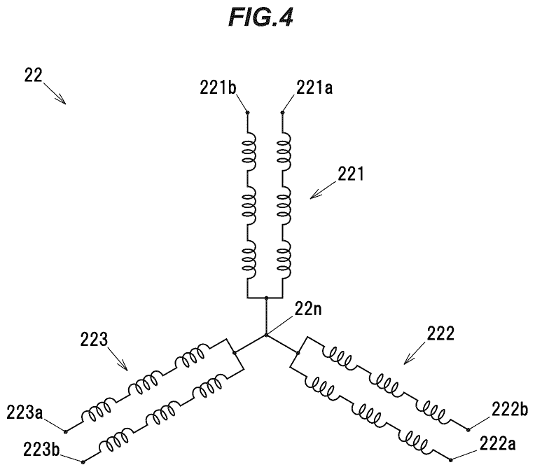

FIG. 4 is a circuit diagram illustrating an example of a configuration of an electric circuit formed by the armature windings 221 to 223 in the rotating electrical machine 2. Each of the U-phase armature winding 221, the V-phase armature winding 222 and the W-phase armature winding 223 is wound on the armature core 220 so that coils are formed at plural locations (six location in the example shown in FIG. 2) and its center portion is connected to a neutral point 22n. A U-phase current is supplied to one and other ends 221a and 221b of the U-phase armature winding 221. A V-phase current is supplied to one and other ends 222a and 222b of the V-phase armature winding 222. A W-phase current is supplied to one and other ends 223a and 223b of the W-phase armature winding 323.

The one end 221a and the other end 221b of the U-phase armature winding 221 are aligned parallel to each other with a predetermined distance and protrude to the outside from the lid member 25. So are the one end 222a and the other end 222b of the V-phase armature winding 222, and the one end 223a and the other end 223b of the W-phase armature winding 223. The one end 221a and the other end 221b of the U-phase armature winding 221, the one end 222a and the other end 222b of the V-phase armature winding 222, and the one end 223a and the other end 223b of the W-phase armature winding 223 protrude from the circumferential edge portion of the lid member 25 so as to be parallel to the rotation axis O and are aligned in a predetermined alignment direction along a circumferential direction of the case 21.

The busbar unit 3 has first to third busbars 31 to 33, first to third connection terminals 34 to 36 respectively attached to the first to third busbars 31 to 33, and a busbar holder 37 that is made of a resin and holds the first to third busbars 31 to 33. The busbar holder 37 is formed of a molded article. Each of the first to third busbars 31 to 33 is the wire-shaped rotating electrical machine wiring component.

Each of the first to third busbars 31 to 33 is an insulated wire formed by covering a conductor wire 31M, 32M, 33M, which is made of a highly conductive metal such as a copper alloy, with an insulation layer 311, 321, 331, which is made of an insulating material such as enamel or fluoroplastic. At both longitudinal ends of the first to third busbars 31 to 33, the insulation layers 311, 321 and 331 are stripped and the conductor wires 31M, 32M, and 33M are exposed. The conductor wires 31M, 32M and 33M in the portions covered with the insulation layers 311, 321 and 33I have a circular cross-section. The first to third busbars 31 to 33 are bent at plural locations in the portions where the conductor wires 31M, 32M and 33M are covered with the insulation layers 311, 321 and 33I.

The first busbar 31 has, at one end in the longitudinal direction, a weld portion 310 to which both the one end 221a and the other end 221b of the U-phase armature winding 221 of the rotating electrical machine 2 are connected by welding. The weld portion 310 extends in an extending direction along the alignment direction of the one end 221a and the other end 221b of the U-phase armature winding 221, and the one end 221a and the other end 221b of the U-phase armature winding 221 are welded to the weld portion 310 at different locations in the extending direction. The first connection terminal 34 is welded or crimped to the first busbar 31 at the other end in the longitudinal direction.

The second busbar 32 has, at one end in the longitudinal direction, a weld portion 320 to which both the one end 222a and the other end 222b of the V-phase armature winding 222 of the rotating electrical machine 2 are connected by welding. The weld portion 320 extends in the extending direction along the alignment direction of the one end 222a and the other end 222b of the V-phase armature winding 222, and the one end 222a and the other end 222b of the V-phase armature winding 222 are welded to the weld portion 320 at different locations in the extending direction. The second connection terminal 35 is welded or crimped to the second busbar 32 at the other end in the longitudinal direction.

The third busbar 33 has, at one end in the longitudinal direction, a weld portion 330 to which both the one end 223a and the other end 223b of the W-phase armature winding 223 of the rotating electrical machine 2 are connected by welding. The weld portion 330 extends in the extending direction along the alignment direction of the one end 223a and the other end 223b of the W-phase armature winding 223, and the one end 223a and the other end 223b of the W-phase armature winding 223 are welded to the weld portion 330 at different locations in the extending direction. The third connection terminal 36 is welded or crimped to the third busbar 33 at the other end in the longitudinal direction.

The first connection terminal 34 is connected to the first washer 41 of the terminal block 4, the second connection terminal 35 to the second washer 42 of the terminal block 4, and the third connection terminal 36 to the third washer 43 of the terminal block 4, respectively by bolts 44, 45, and 46. The first to third washers 41, 42, and 43 are connected to the inverter by wiring (not shown).

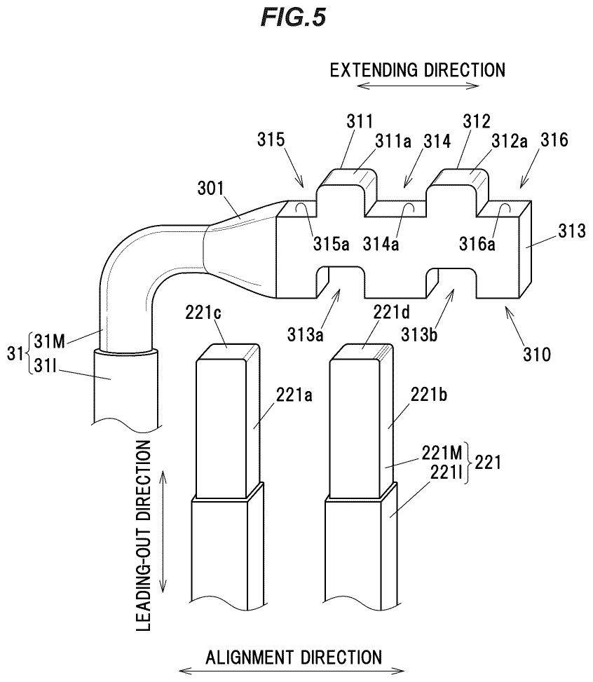

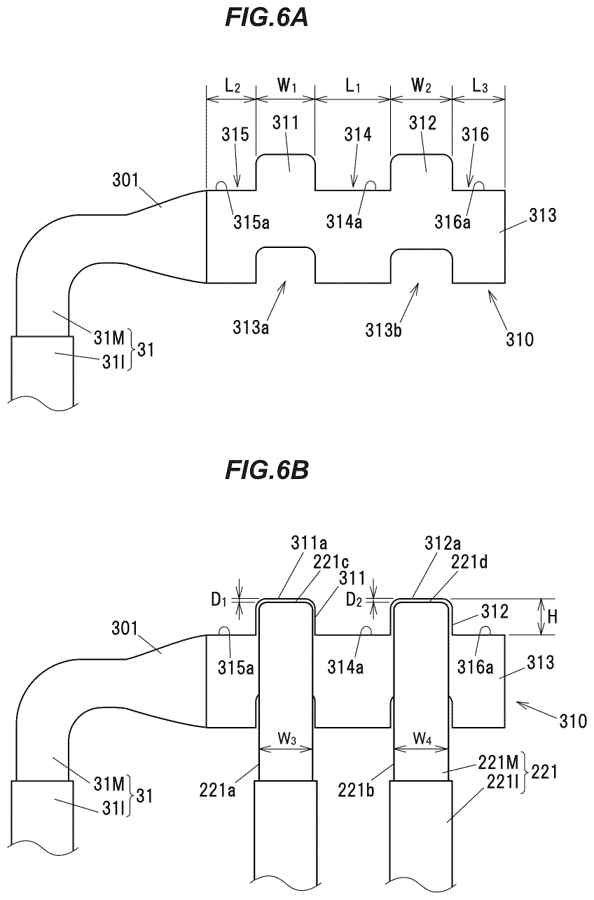

Next, the configuration of the first busbar 31 will be described in detail with reference to FIGS. 5 and 6. The second busbar 32 and the third busbar 33 are configured in the similar manner.

FIG. 5 is a perspective view showing one longitudinal end of the first busbar 31, and the one end 221a and the other end 221b of the U-phase armature winding 221. FIG. 6A is a plan view showing the weld portion 310 of the first busbar 31. FIG. 6B is an explanatory diagram illustrating the one end 221a and the other end 221b of the U-phase armature winding 221 superimposed on the weld portion 310 of the first busbar 31. In FIG. 5, the alignment direction and the leading-out direction of the one end 221a and the other end 221b of the U-phase armature winding 221, and the extending direction of the weld portion 310 are indicated by double-headed arrows. The armature winding 221 is a rectangular insulated wire in which an insulation coating layer 221I made of enamel is formed on an outer surface of a conductor 221M made of a copper alloy, and at the portion to be connected to the welding portion 310 of the first busbar 31, the insulation coating layer 2211 is removed and the conductor 221M is exposed.

The welding portion 310 has a flat plate shape perpendicular to the alignment direction and the leading-out direction of the ends 221a, 221b of the armature winding 221, and is arranged so as to face side surfaces of the ends 221a, 221b of the armature winding 221 along a direction perpendicular to the alignment direction and the leading-out direction of the ends 221a, 221b of the armature winding 221.

Plural protrusions 311, 312 protruding respectively along the ends 221a and 221b of the armature winding 221 are provided on the weld portion 310. In more particular, two protrusions 311, 312 protrude along the leading-out direction of the ends 221a, 221b of the armature winding 221 from a base portion 313 of the weld portion 310 that extends in the alignment direction of the ends 221a, 221b of the armature winding 221. The base portion 313 is a flat rectangular shape on which two recessed portions 313a, 313b are formed at positions aligned with the two protrusions 311, 312 along the leading-out direction of the ends 221a, 221b of the armature winding 221.

The two protrusions 311 and 312 are aligned in the extending direction of the weld portion 310. The weld portion 310 has a central recessed depression 314 between the two protrusions 311, 312, a one-side recessed depression 315 sandwiching the one protrusion 311 between itself and the central recessed depression 314, and an other-side recessed depression 316 sandwiching the other protrusion 312 between itself and the central recessed depression 314. As shown in FIG. 6A, L₂ and L₃ are shorter than L₁, where L₁ is a length of the central recessed depression 314 in the extending direction of the weld portion 310, L₂ is a length of the one-side recessed depression 315, and L₃ is a length of the other-side recessed depression 316. The length of the weld portion 310 in the extending direction is thereby reduced. In addition, L₁ is longer than W₁ and W₂, where W₁ is a width of the one protrusion 311 in the extending direction of the weld portion 310 and W₂ is a width of the other protrusion 312.

The length L₁ of the central recessed depression 314 is set according to the distance between the one end 221a and the other end 221b of the armature winding 221. The widths W₁, W₂ of the protrusions 311, 312 correspond to widths of the ends 221a, 221b of the armature winding 221 in the alignment direction of the ends 221a, 221b. As shown in FIG. 6B, when the widths of the ends 221a and 221b of the armature winding 221 in the alignment direction of the ends 221a and 221b are respectively defined as W₃ and W₄, the width W₁ of the one protrusion 311 is not less than 90% and not more than 110% of the width W₃ of the one end 221a. The width W₂ of the other protrusion 312 is not less than 90% and not more than 110% of the width W₄ of the other end 221b. In this way, since the widths W₁, W₂ of the protrusions 311, 312 are similar to the widths W₃, W₄ of the ends 221a, 221b of the armature winding 221, the protrusions 311, 312 and the ends 221a, 221b of the armature winding 221 can be heated in a balanced manner during welding.

When the weld portion 310 is placed so as to face the ends 221a, 221b of the armature winding 221 as shown in FIG. 6B, the ends 221a, 221b of the armature winding 221 protrude in the leading-out direction beyond a bottom surface 314a of the central recessed depression 314, a bottom surface 315a of the one-side recessed depression 315, and a bottom surface 316a of the other-side recessed depression 316. D₁ and D₂ are not more than 20% of H, desirably not more than 10%, where H is a protruding length of the two protrusions 311, 312 from the bottom surfaces 314a, 315a and 316a, and D₁ and D₂ are distances in the leading-out direction of the ends 221a, 221b of the armature winding 221 between tip surfaces 311a, 312a of the protrusions 311, 312 and tip surfaces 221c, 221d of the ends 221a, 221b. As a result, it is possible to substantially simultaneously melt the protrusions 311, 312 and the ends 221a, 221b of the armature winding 221 when the protrusions 311, 312 and the ends 221a, 221b of the armature winding 221 are heated from the tip surfaces 311a, 312a, 221c, 221d side during welding, and it is thereby possible to perform welding efficiently.

The ends 221a and 221b of the armature winding 221 are melted and fused respectively with the protrusions 311 and 312 of the weld portion 310 and are welded thereto. This welding is, e.g., TIG (Tungsten Inert Gas) welding using an electrode made of tungsten and an inert gas, or laser welding with a high-power laser beam. When performing TIG welding, a torch electrode and a torch nozzle to supply an inert gas to a welding point are arranged so as to face the tip surfaces 221c, 221d of the ends 221a, 221b of the armature winding 221 and the tip surfaces 311a, 312a of the protrusions 311, 312, and an arc discharge is generated between the tip surfaces 221c, 221d, 311a, 312a and the torch electrode. When performing laser welding, the tip surfaces 221c, 221d of the ends 221a, 221b of the armature winding 221 and the tip surfaces 311a, 312a of the protrusions 311, 312 are irradiated with laser light.

Two protrusions 321, 322 protruding from a base portion 323 respectively along the one end 222a and the other end 222b of the V-phase armature winding 222 are provided on the weld portion 320 of the second busbar 32 as shown in FIG. 2A, and these protrusions 321, 322 are welded to the ends 222a, 222b of the V-phase armature winding 222. Two recessed portions 323a, 323b are formed on the base portion 323 at positions aligned with the two protrusions 321, 322.

Likewise, two protrusions 331, 332 protruding from a base portion 333 respectively along the one end 223a and the other end 223b of the W-phase armature winding 223 are provided on the weld portion 330 of the third busbar 33, and these protrusions 331, 332 are welded to the ends 223a, 223b of the W-phase armature winding 223. Two recessed portions 333a, 333b are formed on the base portion 333 at positions aligned with the two protrusions 331, 332.

FIG. 2B shows welded lumps 310a, 310b formed by welding the protrusions 311, 312 of the first busbar 31 to the ends 221a, 221b of the U-phase armature winding 221, welded lumps 320a, 320b formed by welding the protrusions 321, 322 of the second busbar 32 to the ends 222a, 222b of the V-phase armature winding 222, and welded lumps 330a, 330b formed by welding the protrusions 331, 332 of the third busbar 33 to the ends 223a, 223b of the W-phase armature winding 223.

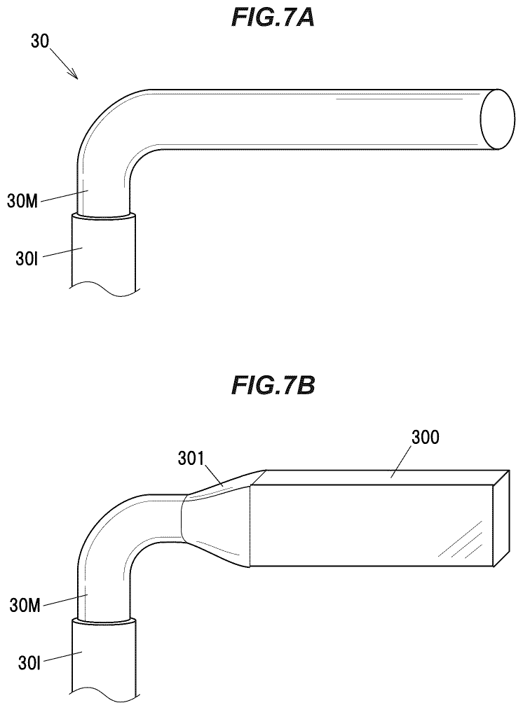

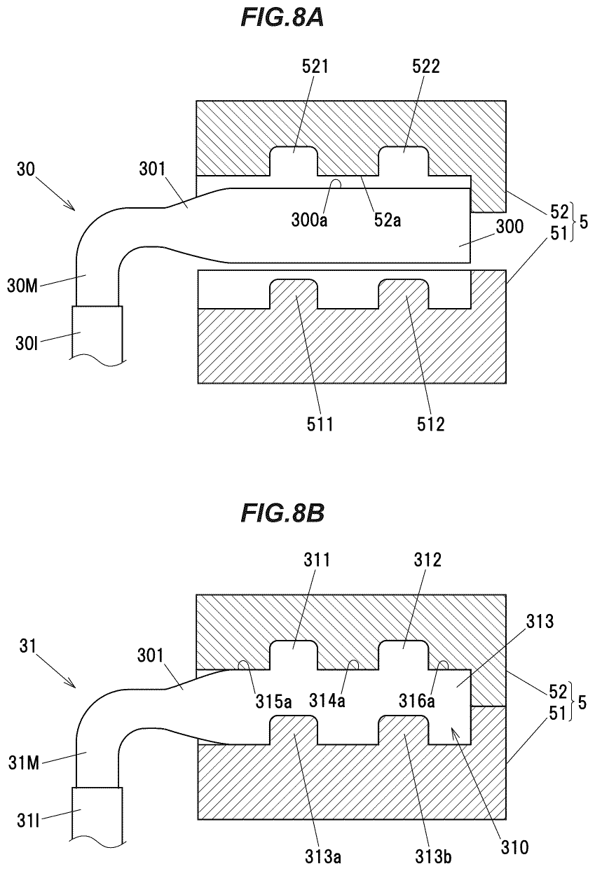

Next, a method for manufacturing the rotating electrical machine assembly 1 will be described with reference to FIGS. 7A to 8B. The rotating electrical machine assembly 1 is manufactured by a manufacturing method that includes a weld portion formation step of forming the weld portions 310, 320, 330 at ends of the first to third busbars 31 to 33 on one side in the longitudinal direction, an arrangement step of arranging the weld portions 310, 320, 330 so as to face the ends 221a, 221b, 222a, 222b, 223a, 223b of the respective phase armature windings 221, 222, 223, and a welding step of melting the protrusions 311, 312, 321, 322, 331, 332 of the weld portions 310, 320, 330 together with the ends 221a, 221b, 222a, 222b, 223a, 223b of the respective phase armature windings 221, 222, 223.

The weld portion formation step of forming the weld portions 310, 320, 330 is a step in which one longitudinal end of a wire-shaped material having a circular cross-section is crushed into a flat plate shape that is long in the longitudinal direction, and the portion formed into a flat plate shape is plastically deformed by pressing in a direction intersecting the longitudinal direction at plural locations to form the plural protrusions 311, 312, 321, 322, 331, 332 that protrude in the direction of this pressing.

FIG. 7A is a perspective view showing a wire-shaped material 30 used to form the first busbar 31. FIG. 7B is a perspective view showing the wire-shaped material 30 when one end in the longitudinal direction is crushed into a rectangular flat plate portion 300 that is long in the longitudinal direction of the wire-shaped material 30. The wire-shaped material 30 is an enameled wire with a circular cross-section that has a conductor wire 30M and an insulation layer 301. In the step of forming the flat plate portion 300, the insulation layer 301 is removed over an area longer than the portion to be the flat plate portion 300 and the conductor wire 30M is plastically deformed by pressing, thereby forming the rectangular flat plate portion 300. The direction of the long side of the flat plate portion 300 coincides with a direction along the longitudinal direction of the wire-shaped material 30. In this regard, the conductor wire 30M and the insulation layer 301 of the wire-shaped material 30 will be the conductor wire 31M and the insulation layer 311 of the first busbar 31 after processing in the weld portion formation step.

By this pressing, a gradually changing portion 301, whose cross-sectional shape in a cross-section perpendicular to the longitudinal direction of the wire-shaped material 30 gradually changes, is formed on one side in the direction of the long side of the flat plate portion 300. The cross-sectional shape of the gradually changing portion 301 is a rectangle in the vicinity of the flat plate portion 300 and gradually changes to a circle as the distance from the flat plate portion 300 increases. At the portion to be the gradually changing portion 301, the insulation layer 311 is removed in advance.

FIGS. 8A and 8B are explanatory diagrams illustrating a step of forming the protrusions 311, 312 on the flat plate portion 300. In this step, the plural protrusions 311 and 312 are formed on the flat plate portion 300 by pressing using a die 5 having a raised die 51 and a recessed die 52. Two raised portions 511 and 512 having shapes corresponding to the protrusions 311 and 312 are formed on the raised die 51, and two recessed portions 521 and 522 having shapes corresponding to the protrusions 311 and 312 are formed on the recessed die 52.

The flat plate portion 300 is placed between the raised die 51 and the recessed die 52, and the raised die 51 and the recessed die 52 are brought close to each other to plastically deform the flat plate portion 300, resulting in that portions of the flat plate portion 300 are pushed into the recessed portions 521, 522 by the raised portions 511, 512, and the weld portion 310 having the protrusions 311, 312 is thereby formed. The recessed portions 313a and 313b are formed at the portions against which the raised portions 511 and 512 of the raised die 51 are pressed. That is, the protrusions 311 and 312 are formed by plastic flow of the flat plate portion 300 caused by pressing using the die 5. An end face 300a of the flat plate portion 300, which is an end face in a direction of the short side and faces a portion of an inner surface 52a of the recessed die 52 on which the recessed portions 521 and 522 are not formed, will be the bottom surface 314a of the central recessed depression 314, the bottom surface 315a of the one-side recessed depression 315, and the bottom surface 316a of the other-side recessed depression 316 after the pressing. Contact of the end face 300a in the direction of the short side of the flat plate portion 300 with the inner surface 52a of the recessed die 52 on both sides of the recessed portions 521 and 522 allows the protrusions 311 and 312 to be formed with high shape accuracy. The weld portions 320, 330 of the second busbar 32 and the third busbar 33 are also formed by the same processing method as that for the first busbar 31.

In the arrangement step, the weld portion 310 of the first busbar 31 is placed so that the ends 221a, 221b of the U-phase armature winding 221 extend in the protruding direction of the protrusions 311, 312 beyond the portions of the weld portion 310 on which the protrusions 311, 312 are not formed. The weld portion 320 of the second busbar 32 is placed so that the ends 222a, 222b of the V-phase armature winding 222 extend in the protruding direction of the protrusions 321, 322 beyond the portions of the weld portion 320 on which the protrusions 321, 322 are not formed. The weld portion 330 of the third busbar 33 is placed so that the ends 223a, 223b of the W-phase armature winding 223 extend in the protruding direction of the protrusions 331, 332 beyond the portions of the weld portion 330 on which the protrusions 331, 332 are not formed.

After that, in the welding step, the ends 221a, 221b of the U-phase armature winding 221 are welded to the protrusions 311, 312 of the weld portion 310 of the first busbar 31, the ends 222a, 222b of the V-phase armature winding 222 are welded to the protrusions 321, 322 of the weld portion 320 of the second busbar 32, and the ends 223a, 223b of the W-phase armature winding 223 are welded to the protrusions 331, 332 of the weld portion 330 of the third busbar 33, as shown in FIG. 2B.

Through the above steps, the rotating electrical machine assembly 1 is obtained. After the welding step, an insulating coating may be applied to the portions, including the weld portions 310, 320, and 330, of the first to third busbars 31 to 33 at which the insulation layers 311, 321, and 33I are removed.

### Functions and Effects of the Embodiment

In the embodiment described above, heat during welding of each of the weld portions 310, 320, 330 is concentrated on the protrusions 311, 312, 321, 322, 331, 332, and it is thereby possible to quickly weld the armature windings 221 to 223 of the rotating electrical machine 2 to the first to third busbars 31 to 33. In addition, since the protrusions 311, 312, 321, 322, 331, 332 are provided, it is possible to easily position the ends 221a, 221b of the U-phase armature winding 221, the ends 222a, 222b of the V-phase armature winding 222, and the ends 223a, 223b of the W-phase armature winding 223 in predetermined places respectively relative to the weld portions 310, 320, 330 of the first to third busbars 31 to 33. Furthermore, since the recessed portions 313a, 313b, 323a, 323b, 333a, 333b are respectively formed on the weld portions 310, 320, 330 of the first to third busbars 31 to 33, positioning can be also performed by the recessed portions 313a, 313b, 323a, 323b, 333a, 333b in addition to the protrusions 311, 312, 321, 322, 331, 332. This enhances the effect of making the positioning in predetermined places relative to the weld portions 310, 320, and 330 easy.

### Summary of the Embodiment

Technical ideas understood from the embodiment will be described below citing the reference signs, etc., used for the embodiment. However, each reference sign, etc., described below is not intended to limit the constituent elements in the claims to the members, etc., specifically described in the embodiment.

According to the first feature, a rotating electrical machine wiring component (the first to third busbar 31 to 33) having a wire shape and configured to be connected to a plurality of ends 221a, 221b, 222a, 222b, 223a, 223b of an armature winding 221, 222, 223 aligned in parallel in a predetermined alignment direction, the wiring component 31 to 33 for rotating electrical machine including: a weld portion 310, 320, 330 that is provided at one longitudinal end and is connected to the plurality of ends 221a, 221b, 222a, 222b, 223a, 223b of the armature winding 221, 222, 223 by welding, wherein the weld portion 310, 320, 330 extends in an extending direction along the alignment direction, and wherein the weld portion 310, 320, 330 includes protrusions 311, 312, 321, 322, 331, 332 that protrude respectively along the plurality of ends 221a, 221b, 222a, 222b, 223a, 223b of the armature winding 221, 222, 223.

According to the second feature, in the rotating electrical machine wiring component 31 to 33 as described by the first feature, the weld portion 310, 320, 330 has a flat plate shape perpendicular to the alignment direction and a leading-out direction of the plurality of ends 221a, 221b, 222a, 222b, 223a, 223b of the armature winding 221, 222, 223.

According to the third feature, in the rotating electrical machine wiring component 31 as described by the second feature, the weld portion 310 includes two of the protrusions 311, 312 aligned in the extending direction, a central recessed depression 314 between the two protrusions 311, 312, a one-side recessed depression 315 sandwiching one protrusion 311 of the two between itself and the central recessed depression 314, and an other-side recessed depression 316 sandwiching the other protrusion 312 of the two between itself and the central recessed depression 314.

According to the fourth feature, in the rotating electrical machine wiring component 31 as described by the third feature, a length L₂ of the one-side recessed depression 315 and a length L₃ of the other-side recessed depression 316 in the extending direction are smaller than a length L₁ of the central recessed depression 314 in the extending direction.

According to the fifth feature, a connection structure of wiring component 31 for rotating electrical machine that is a structure to connect a plurality of ends 221a, 221b of an armature winding 221 aligned in parallel in a predetermined alignment direction to a wire-shaped wiring component 31 for rotating electrical machine, the connection structure including: a weld portion 310 that is provided at one longitudinal end of the rotating electrical machine wiring component 31 and is connected to the plurality of ends 221a, 221b of the armature winding 221 by welding, wherein the weld portion 310 extends in an extending direction along the alignment direction; and the weld portion 310 includes protrusions 311, 312 that protrude respectively along the plurality of ends 221a, 221b of the armature winding 221, and wherein the protrusions 311, 312 are melted and fused respectively with the plurality of ends 221a, 221b of the armature winding 221.

According to the sixth feature, a method for manufacturing a rotating electrical machine assembly 1 that includes a rotating electrical machine 2, in which a plurality of ends of an armature winding 221, 222, 223 led out of an armature core 220 are aligned in parallel to each other in a predetermined alignment direction, and a wire-shaped wiring component 31-33 for rotating electrical machine connected to the plurality of ends 221a, 221b, 222a, 222b, 223a, 223b of the armature winding 221, 222, 223, the method including: forming, at one end in a longitudinal direction of the wiring component 31-33 for rotating electrical machine, a weld portion 310, 320, 330 that includes protrusions 311, 312, 321, 322, 331, 332 protruding respectively along the plurality of ends 221a, 221b, 222a, 222b, 223a, 223b of the armature winding 221, 222, 223; arranging the weld portion 310, 320, 330 of the wiring component 31-33 for rotating electrical machine so as to face the plurality of ends 221a, 221b, 222a, 222b, 223a, 223b of the armature winding 221, 222, 223; and welding the weld portion 310, 320, 330 to the plurality of ends 221a, 221b, 222a, 222b, 223a, 223b of the armature winding 221, 222, 223 by melting the protrusions 311, 312, 321, 322, 331, 332 together with the plurality of ends 221a, 221b, 222a, 222b, 223a, 223b of the armature winding 221, 222, 223.

According to the seventh feature, in the method for manufacturing a rotating electrical machine assembly 1 as described by the sixth feature, the step of forming the weld portion 310, 320, 330 is a step in which one end in a longitudinal direction of a wire-shaped material 30 having a circular cross-section is crushed into a flat plate shape that is long in the longitudinal direction, and the portion 300 formed into a flat plate shape is plastically deformed by pressing in a direction intersecting the longitudinal direction at a plurality of locations to form the protrusions 311, 312, 321, 322, 331, 332 that protrude in a direction of the pressing.

According to the eighth feature, in the method for manufacturing a rotating electrical machine assembly 1 as described by the sixth or seventh feature, the arranging step is a step in which the weld portion 310, 320, 330 is arranged so that the plurality of ends 221a, 221b, 222a, 222b, 223a, 223b of the armature winding 221, 222, 223 extend in a protruding direction of the protrusions 311, 312, 321, 322, 331, 332 beyond a portion of the weld portion 310, 320, 330 on which the protrusions 311, 312, 321, 322, 331, 332 are not formed.

Although the embodiment has been described, the invention according to claims is not to be limited to the embodiment described above. Further, please note that not all combinations of the features described in the embodiment are necessary to solve the problem of the invention.

1. A rotating electrical machine wiring component having a wire shape and configured to be connected to a plurality of ends of an armature winding aligned in parallel in a predetermined alignment direction, the rotating electrical machine wiring component comprising:
a weld portion that is provided at one longitudinal end and is connected to the plurality of ends of the armature winding by welding,
wherein the weld portion extends in an extending direction along the alignment direction, and
wherein the weld portion comprises protrusions that protrude respectively along the plurality of ends of the armature winding.

2. The rotating electrical machine wiring component, according to claim 1, wherein the weld portion has a flat plate shape perpendicular to the alignment direction and a leading-out direction of the plurality of ends of the armature winding.

3. The rotating electrical machine wiring component, according to claim 2, wherein the weld portion comprises two of the protrusions aligned in the extending direction, a central recessed depression between the two protrusions, a one-side recessed depression sandwiching one of the two protrusions between itself and the central recessed depression, and an other-side recessed depression sandwiching the other of the two protrusions between itself and the central recessed depression.

4. The rotating electrical machine wiring component, according to claim 3, wherein a length of the one-side recessed depression and a length of the other-side recessed depression in the extending direction are smaller than a length of the central recessed depression in the extending direction.

5. A rotating electrical machine wiring component-connection structure configured to connect a plurality of ends of an armature winding aligned in parallel in a predetermined alignment direction to a rotating electrical machine wiring component having a wire shape, the rotating electrical machine wiring component-connection structure comprising:
a weld portion that is provided at one longitudinal end of the rotating electrical machine wiring component and is connected to the plurality of ends of the armature winding by welding,
wherein the weld portion extends in an extending direction along the alignment direction,
wherein the weld portion comprises protrusions that protrude respectively along the plurality of ends of the armature winding, and
wherein the protrusions are melted and fused respectively with the plurality of ends of the armature winding.

6. A method for manufacturing a rotating electrical machine assembly that comprises a rotating electrical machine, in which a plurality of ends of an armature winding led out of an armature core are aligned in parallel to each other in a predetermined alignment direction, and a rotating electrical machine wiring component having a wire shape and connected to the plurality of ends of the armature winding, the method comprising:
forming, at one end in a longitudinal direction of the rotating electrical machine wiring component, a weld portion that comprises protrusions protruding respectively along the plurality of ends of the armature winding;
arranging the weld portion of the rotating electrical machine wiring component so as to face the plurality of ends of the armature winding; and
welding the weld portion to the plurality of ends of the armature winding by melting the protrusions together with the plurality of ends of the armature winding.

7. The method, according to claim 6, wherein the forming the weld portion comprises crushing one end in a longitudinal direction of a wire-shaped material having a circular cross-section into a flat plate shape that is long in the longitudinal direction, and plastically deforming the portion formed into a flat plate shape by pressing in a direction intersecting the longitudinal direction at a plurality of locations to form the protrusions that protrude in a direction of the pressing.

8. The method, according to claim 6, wherein the arranging comprises arranging the weld portion so that the plurality of ends of the armature winding extend in a protruding direction of the protrusions beyond a portion of the weld portion on which the protrusions are not formed.
